(19) United States
(12) Patent Application Publication
(10) Pub. No.: US 2010/0023691 A1
(43) Pub. Date: Jan. 28, 2010

(54) SYSTEM AND METHOD FOR IMPROVING A BROWSING RATE IN A HOME NETWORK

(75) Inventor: Ho-Chul SHIN, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/510,719

(22) Filed: Jul. 28, 2009

(30) Foreign Application Priority Data
Jul. 28, 2008 (KR) 10-2008-0073635

(51) Int. Cl. G06F 3/048; G06F 12/08

(52) U.S. Cl. 711/118; 715/854; 711/E12.017

(57) ABSTRACT

A system and method for improving a browsing rate in a Universal Plug and Play (UPnP) Audio/Video (AV) home network. A control point predicts browse data using a pre-fetching operation and pre-fetches and stores the predicted browse data, which is temporarily stored in a cache implemented in the control point. Accordingly, when a user has selected a corresponding container, the control point displays the pre-fetched browse data. The user can directly use the browse data and experiences a fast response.

### PRIORITY

This application claims priority under 35 U.S.C. §119(a) to a Korean Patent Application filed in the Korean Intellectual Property Office on Jul. 28, 2008 and assigned Serial No. 10-2008-0073635, the contents of which are incorporated herein by reference.

### BACKGROUND OF THE INVENTION

1. Field of the Invention

The present invention relates generally to a system and method for improving a browsing rate in a home network, and in particular, to a system and method for improving a browsing rate using a pre-fetching operation in a Universal Plug and Play (UPnP) Audio/Video (AV) home network.

2. Description of the Related Art

A home network uses next-generation Information Technology (IT) for maximizing living convenience in combination with the Internet based on control, management, integration and interface for home information appliances. The home network is divided, according to its technical layer, into a lower network technology for physical data transmission, a middleware technology for interfacing with an upper application, and an information appliance technology applied to each home appliance.

At present, there are various home network middlewares such as UPnP, Java Intelligent Network Infrastructure (Jini), Open Service Gateway Initiative (OSGi) and Home Audio/Video Interoperability (HAVi), corresponding to an interface between a lower network layer and an application layer for controlling and managing the information appliances. Among these, the UPnP is widely used to automatically connect network devices in a Peer to Peer (P2P) manner. The UPnP is the open architecture for automatically connecting network devices on the basis of protocols such as Internet Protocol version 4 (IPv4), HyperText Transfer Protocol (HTTP), eXtensible Markup Language (XML) and Simple Object Access Protocol (SOAP).

A UPnP AV home network is configured by a media server for providing media contents, a media renderer for rendering the media contents, and a control point for allowing a user to control the media server and the media renderer. Among these, the media server may read information about its own media contents through a Content Directory Service (CDS). The CDS may display objects possessed by the media server in a tree structure through the control point. The objects are classified into a container having other object information and an item as media file information.

In the UPnP AV home network, a browse or search for finding media contents to be rendered by the control point or the user is defined. Currently, the SOAP protocol is used.

FIG. 1 illustrates a conventional browse request process. When a user makes a browse request in step 100, the actual browse request is transmitted to the media server in step 110. The media server transmits a response including browse data to the control point in response to the request. Accordingly, upon receipt of the actual browse response in step 120, the control point displays the browse request, such as a content list, in step 130. A given waiting time is required until the response is received after the browse request.

To conventionally browse a desired content list as described above, the control point transmits a browse request using SOAP and the media server transmits a response including the content list to the control point. The SOAP causes a long waiting time due to a HyperText Transfer Protocol (HTTP) exchange mechanism, complex Extensible Markup Language (XML) processing, and a media server processing time. Thus, an interaction application in the control point inconveniences the user by round-trip latencies due to an iterative browse request and response.

### SUMMARY OF THE INVENTION

An aspect of the present invention is to address at least the problems and/or disadvantages and to provide at least the advantages described below. Accordingly, an aspect of the present invention is to provide a system and method for improving a browsing rate using a pre-fetching operation in a UPnP AV home network.

According to the present invention, there is provided a system for improving a browsing rate in a home network, including a control point that displays initial browse data of a tree structure when a content directory service is detected, determines the next browse data selectable by a user in a display state, transmits a browse request for pre-fetching the determined browse data, and stores browse data included in a response in an internally implemented cache when the response is received, and a media server that transmits the response including the browse data to the request when the browse request is received from the control point.

According to the present invention, there is provided a method for improving a browsing rate of a control point in a home network including the control point and a media server, including displaying initial browse data of a tree structure when a content directory service is detected, determining the next browse data selectable by a user in a display state, transmitting a browse request for pre-fetching the determined browse data, and storing browse data included in a response in an internally implemented cache when the response is received.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates a conventional browse request process;

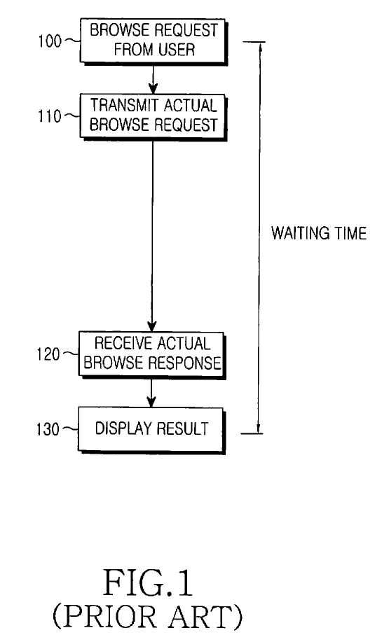

FIG. 2 illustrates a UPnP AV home network according to the present invention;

FIG. 3 illustrates a control point according to the present invention; and

FIG. 4 illustrates a cache and a pre-fetching operation in the control point according to the present invention.

Throughout the drawings, the same drawing reference numerals will be understood to refer to the same elements, features and structures.

### DETAILED DESCRIPTION OF THE PREFERRED EMBODIMENTS

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for the sake of clarity and conciseness.

The present invention discloses a system and method for improving a browsing rate in a UPnP AV home network. A control point predicts browse data using a pre-fetching operation and pre-fetches and stores the predicted browse data. At this time, the browse data is temporarily stored in a cache implemented in the control point. Accordingly, when a user has selected a corresponding container, the control point displays the pre-fetched browse data. The user can directly use the browse data and expect a fast response.

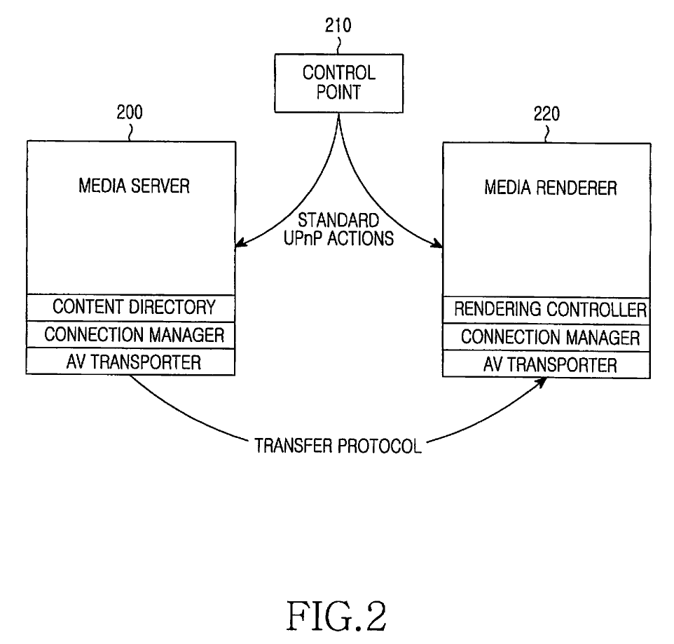

FIG. 2 illustrates a UPnP AV home network according to the present invention

Referring to FIG. 2, the UPnP AV home network includes a media server 200 for providing media contents, a media renderer 220 for rendering the media contents, and a control point 210 for allowing the user to control the media server 200 and the media renderer 220. All UPnP actions between the media server 200/media renderer 220 and the control point 210 are performed through a SOAP protocol. The streaming of media contents from the media server 200 to the media renderer 220 uses an out-of-band transfer protocol.

The media server 200 includes a content directory functioning as a database to store and manage content information, a connection manager to assist in connecting the media server 200 and the media renderer 220, and an Audio/Video (AV) transporter to assist in transporting information.

The media renderer 220 includes a rendering controller to control a rendering operation, a connection manager to assist in connecting the media server and the media renderer, and an AV transporter to assist in transporting information.

The control point 210 controls and manages the operations of the media server 200 and the media renderer 220 as designated by the user. The control point 210 provides a user interface application such that the user can control the device operation. For example, the control point may include a wireless Portable Digital Assistant (PDA).

The control point 210 transmits a browse request to the media server 200 and receives a service for listing available contents from the media server 200. The browse request enables the control point 210 to receive detailed information of contents capable of being provided by the media server 200. At this time, the browse request includes a container Identifier (ID), a start index, and the number of returns. In response to the browse request, the media server 200 provides the control point 210 with a response that includes browse data.

In particular, to minimize a waiting time due to the browse request and response, the control point 210 uses a pre-fetching operation and a cache mechanism. The pre-fetching operation is for predicting the next selection of the user when tree-structured objects are displayed and storing a response after pre-transmitting a browse request to acquire browse data corresponding to the predicted selection. That is, the pre-fetching operation occurs before the cache is prepared for the user's selection. Here, the browse data acquired through the pre-fetching operation indicates objects classified into a container having other object information and an item as media file information.

Since the user can navigate a tree-structured container, the container must be displayed according to movement whenever the user moves the container. Accordingly, the control point 210 must pre-fetch all nodes selectable by the user, that is, selectable target containers, so as to prevent a browse request from being generated whenever the container moves. Since the next nodes to be pre-fetched have the tree structure, necessary nodes can be predicted. For example, the selectable target containers are a parent container of a selected container, a previous node of the container, the next node of the container, children containers of the container, and root containers of a detected CDS.

A cache hit rate of 100% can be realized, but all of the data within the CDS is not browsed. Since necessary browse data may be predicted and pre-fetched through the pre-fetching operation whenever the user performs navigation, all of the browse data does not need to be pre-stored in the cache. When browse data corresponding to the user's selection exists in the cache, the control point 210 minimizes an additional browse request by using the browse data. When desired browse data does not exist in the cache, the control point 210 performs the pre-fetching operation to pre-add browse data selectable by the user to the cache.

For example, the pre-fetching operation is performed while corresponding browse data existing in the cache is found and displayed so as to display a user request result. In a current display state, the control point 210 determines whether the next browse data selectable by the user exists, pre-fetches necessary data through the pre-fetching operation when the next browse data does not exist, and adds the pre-fetched data to the cache. Since minimal browse data required initially is pre-stored in the cache and the next browse data acquired through the pre-fetching operation is added to the cache, the control point 210 can directly locate and provide desired browse data from the cache in response to a user browse request without a waiting time delay.

The control point 210 can receive detailed information about contents through the CDS of the media server 200. The CDS can display objects possessed by the media server 200 in the tree structure. When the control point 210 initially detects the CDS of the media server 200 for the pre-fetching operation, a root container of the CDS must be pre-fetched preferentially. When the user selects one container, the next nodes selectable by the user must be pre-fetched.

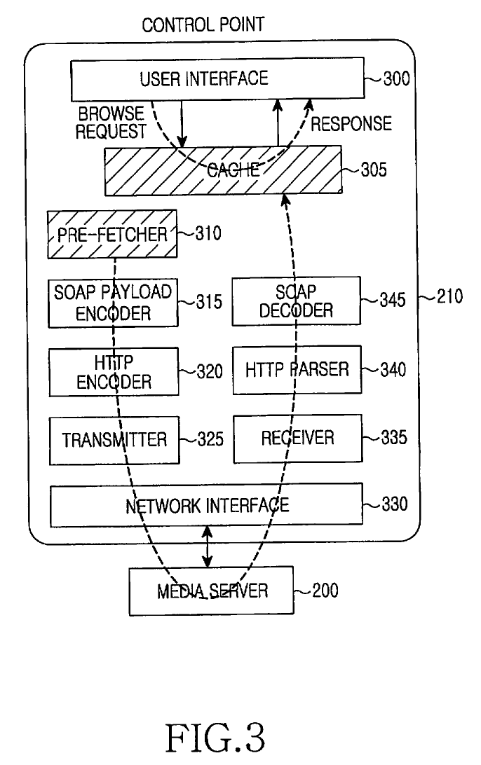

FIG. 3 illustrates the control point according to the present invention.

Referring to FIG. 3, the control point 210 includes a user interface 300, a SOAP payload encoder 315, an HTTP encoder 320, a transmitter 325, a network interface 330, a receiver 335, an HTTP parser 340, and an SOAP decoder 345. The control point 210 further includes a cache 305 and a pre-fetcher 310 as constituent elements for improving a browsing rate according to the present invention.

The user interface 300 as a means for receiving a user browse request assists in displaying a response to the request. The cache 305 can pre-store minimal objects such that the user can use a desired object in the control point 210 even when the browse request is not initially made. However, since a data accumulation process through iterative learning is required to fetch and store all objects within the CDS in the cache 305, a pre-fetching scheme is used in consideration of the above-described process. Accordingly, a necessary pre-fetching operation result is stored in the cache 305 before the user makes the next selection. Specifically, whenever the user selects one container of the CDS in the tree structure, objects corresponding to the selection are acquired through the pre-fetching operation and stored in the cache 305.

The pre-fetcher 310 predicts browse data of necessary objects corresponding to the user's selection and then generates prediction information for pre-fetching the browse data from the media server 200. As described above, the pre-fetcher 310 assists in predicting information about the next nodes selectable by the user when the user has selected one container. The prediction information indicates a parent container of a selected container, a previous node of the container, the next node of the container, children containers of the container, and root containers of a detected CDS.

Accordingly, the SOAP payload encoder 315 generates a browse request including prediction information provided from the pre-fetcher 310 using the SOAP protocol, encodes the generated request in the form of XML, and outputs the encoded request to the transmitter 325. The transmitter 325 transmits the browse request to the media server 200 through the network interface 330. When a response is received from the media server 200 through the network interface 330 and the receiver 335, the HTTP parser 340 parses the response and the SOAP decoder 345 decodes the parsed response using the SOAP protocol. The decoded response is stored in the cache 305.

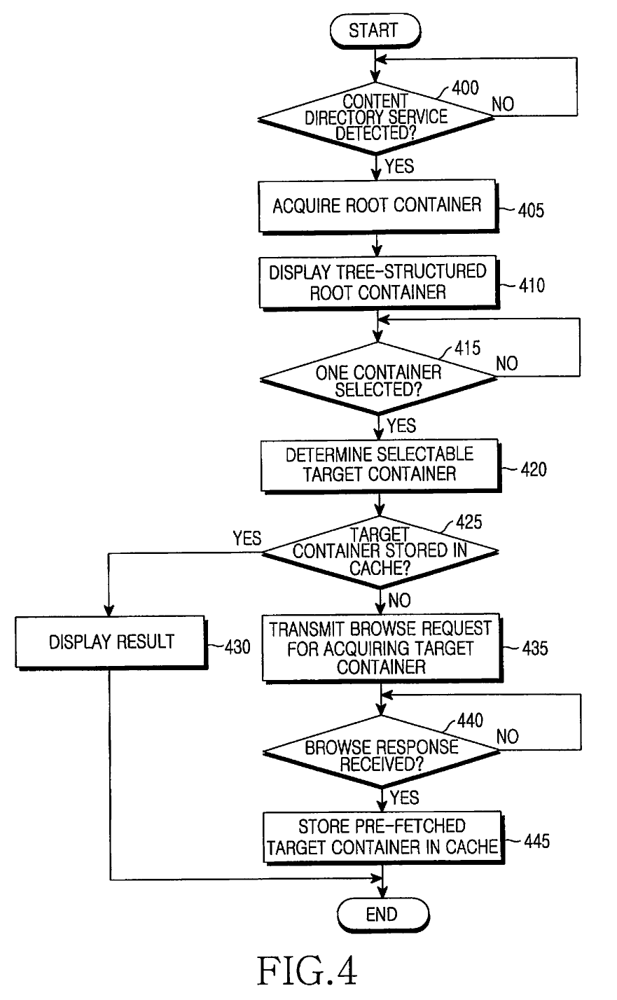

FIG. 4 illustrates the cache and the pre-fetching operation in the control point according to the present invention.

Referring to FIG. 4, the control point determines whether the CDS of the media server is detected when a browse request has been input from the user in step 400. When the CDS is detected as the determination result, the control point must preferentially display a root container to allow the user to navigate a container in the CDS. Accordingly, the control point acquires the root container in step 405. At this time, the control point preferentially accesses the cache instead of transmitting a browse request for acquiring the root container to the media server. When the root container exists in the cache, the root container is directly acquired and used from the cache. However, when the root container does not exist, the root container is acquired through the browse request.

Subsequently, in step 410, the control point displays a browse request result, such that the tree-structured root container is displayed. While the result is displayed, the control point determines whether one container of tree-structured containers is selected in step 415. When one container is selected as the determination result, target containers selectable by the user are determined in step 420.

Here, the selectable target containers are, for example, a parent container of a user-selected container, a previous node of the container, the next node of the container, children containers of the container, and root containers of a detected CDS.

Then, the control point determines whether the determined target container exists in the cache in step 425. When the target container exists as the retrieval result, the result is displayed using the target container existing in the cache in step 430. Here, the cache is retrieved with a Universally Unique Identifier (UUID) of the media server, a container object ID, and a container object index such that requests on containers are distinguished. When an entry matching a desired container is retrieved, objects existing in the cache are used for a direct response instead of a response to an actual browse request.

Otherwise, when no target container exists in the cache, the control point performs a pre-fetching operation. Accordingly, the control point transmits a browse request for target container acquisition to the media server in step 435. Subsequently, when the control point receives a browse response in step 440, a pre-fetched target container is stored in the cache in step 445. The response to the browse request is stored in the cache and indexed by a UUID, an object ID, and a container start index.

When a larger number of objects than those capable of being acquired by the browse request exist in the container, the next selectable objects among the remaining objects must be pre-fetched through the browse request. As described above, the control point directly uses a container existing in the cache whenever the user moves a container after predicting the container to be moved by the user, pre-fetching a target container from the media server, and adding the pre-fetched container to the cache. Thus, the user can directly view a container movement result without waiting whenever the user moves a container.

According to the present invention, a waiting time for a response to a browse request to be received is reduced by a faster browsing method using a pre-fetching operation. According to the present invention, browse data can be pre-fetched using a pre-fetching operation and faster responsiveness can be provided to a user, thereby eliminating user.

While the invention has been shown and described with reference to a preferred embodiment thereof, it will be understood by those skilled in the art that various changes in form and details may be made therein without departing from the spirit and scope of the invention as defined by the appended claims.

What is claimed is:

1. A system for improving a browsing rate in a home network, comprising:
a control point for displaying initial browse data of a tree structure when a content directory service is detected, determining the next browse data selectable by a user, transmitting a browse request for pre-fetching the determined next browse data, and storing the next browse data included in a response in a cache when the response is received; and
a media server for transmitting the response including the next browse data when the browse request is received from the control point.

2. The system of claim 1, wherein the next browse data is objects classified into a container having other object information and an item as media file information.

3. The system of claim 2, wherein the initial browse data is a root container.

4. The system of claim 2, wherein the control point determines the next target container selectable by the user when one container is selected by the user, determines whether the target container exists in the cache, and uses the target container existing in the cache when the target container exists in the cache.

5. The system of claim 4, wherein the determined next browse data is at least one of a parent container of the selected container, a previous node of the container, the next node of the container, children containers of the container, and root containers of the detected content directory service.

6. The system of claim 4, wherein the control point transmits a browse request for pre-fetching the target container when the target container does not exist in the cache, and stores the target container included in a response in the cache when the response is received.

7. A method for improving a browsing rate of a control point in a home network including the control point and a media server, comprising:
displaying initial browse data of a tree structure when a content directory service is detected;
determining the next browse data selectable by a user;
transmitting a browse request for pre-fetching the determined next browse data; and
storing the next browse data included in a response in a cache when the response is received.

8. The method of claim 7, wherein the next browse data is objects classified into a container having other object information and an item as media file information.

9. The method of claim 7, wherein the initial browse data is a root container.

10. The method of claim 8, further comprising:
determining whether one container is selected by the user;
determining the next target container selectable by the user when the one container is selected by the user;
determining whether the target container exists in the cache when the next container is determined; and
using the target container existing in the cache when the target container exists in the cache.

11. The method of claim 7, wherein the determined next browse data is at least one of a parent container of the selected container, a previous node of the container, the next node of the container, children containers of the container, and root containers of the detected content directory service.

12. The method of claim 10, wherein transmitting the browse request includes transmitting a browse request for pre-fetching the target container when the target container does not exist in the cache.
